(19) United States
(12) Patent Application Publication
(10) Pub. No.: US 2005/0275895 A1
(43) Pub. Date: Dec. 15, 2005

(54) Method and apparatus for presenting an image

(76) Inventor: Dennis Howard, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/853,887

(22) Filed: May 26, 2004

(51) Int. Cl. G06K 15/02; H04N 1/387

(52) U.S. Cl. 358/1.18; 358/452

(57) ABSTRACT

A method for presenting an image includes providing, to an image producing device, an image masking boundary that is non-rectangular in shape, and generating a masked image with the image producing device by applying the image masking boundary to an image and modifying a portion of the image that is outside the image masking boundary.

### BACKGROUND OF THE INVENTION

Some image producing devices such as commercially-available multifunctional printer (MFPs) are provided with image processing capabilities including image adjustment features that are initiated by a user, or that receive and process inputs provided by the user. For example, some MFPs allow users to erase a border or selected edges of a scanned image, resulting in a smaller image that is rectangular in shape.

Image producing devices that can only generate rectangular images are not always well suited for reproducing images of objects that are irregular in shape. For example, a user may wish to photocopy a particular object in an image but to change or eliminate portions of the image around the object. One solution is to manually cut a border of a certain shape before making copies. This is tedious, error-prone, and potentially destroys the original for other uses. Another solution is to scan the image to create an image file, edit the image at a personal computer, workstation, etc., and then send a print job (containing edited image information) to a printer for printing.

It would be desirable to be able to provide users of image producing devices with a way to generate modified images without irreversibly damaging source materials, or without having to use (and, in some instances, waste time locating and/or learning how to use) additional equipment such as a scanner and a computer with image editing capabilities. It would also be desirable to be able to provide a “stand alone” image producing device with flexible image editing capabilities which are accessible via a simple, user-friendly interface.

### BRIEF DESCRIPTION OF THE DRAWINGS

Detailed description of embodiments of the invention will be made with reference to the accompanying drawings:

FIG. 1 illustrates an image producing device configured according to an example embodiment of the present invention;

FIG. 2 illustrates an example embodiment of a user interface for an image producing device;

FIG. 3A depicts an original image;

FIG. 3B depicts an image masking boundary applied within a boundary of an image to be presented;

FIG. 3C depicts an example of a masked image generated by applying the image masking boundary of FIG. 3B to the original image of FIG. 3A;

FIG. 4 illustrates another example embodiment of a user interface that includes a one-line display;

FIG. 5 illustrates an example menu structure that can be presented at the one-line display of FIG. 4;

FIG. 6A illustrates an example pre-saved mask image;

FIG. 6B illustrates an example adjusted mask image; and

FIG. 7 illustrates an example process flow.

### DETAILED DESCRIPTION

The following is a detailed description for carrying out the invention. This description is not to be taken in a limiting sense, but is made merely for the purpose of illustrating the general principles of the invention.

In an example embodiment, the present invention involves providing an image producing device with image editing functionality that allows a user of the image producing device to select a non-rectangular image masking boundary from a menu of different image masking boundaries. The image producing device (e.g., a digital copier) uses the non-rectangular image masking boundary to identify, within an image, the bounds of a non-rectangular region that is to be presented (e.g., copied) by the image producing device. The image masking boundary also serves to define a portion of the image (e.g., outside of the image masking boundary) that is to be discarded, occluded or modified in some fashion.

The principles of the present invention are applicable to printers, multifunctional printers (MFPs), copiers (e.g., monochrome or color digital copiers), or any other type of image producing device. The principles of the present invention are applicable to devices with the capability to scan an image into a memory device, manipulate or edit the image digitally, and then print the resulting modified image on paper or some other form of print media. By way of example, the principles of the present invention are applicable to mid-range or high-end color copiers, as well as monochrome and lower-end multi-function peripheral devices.

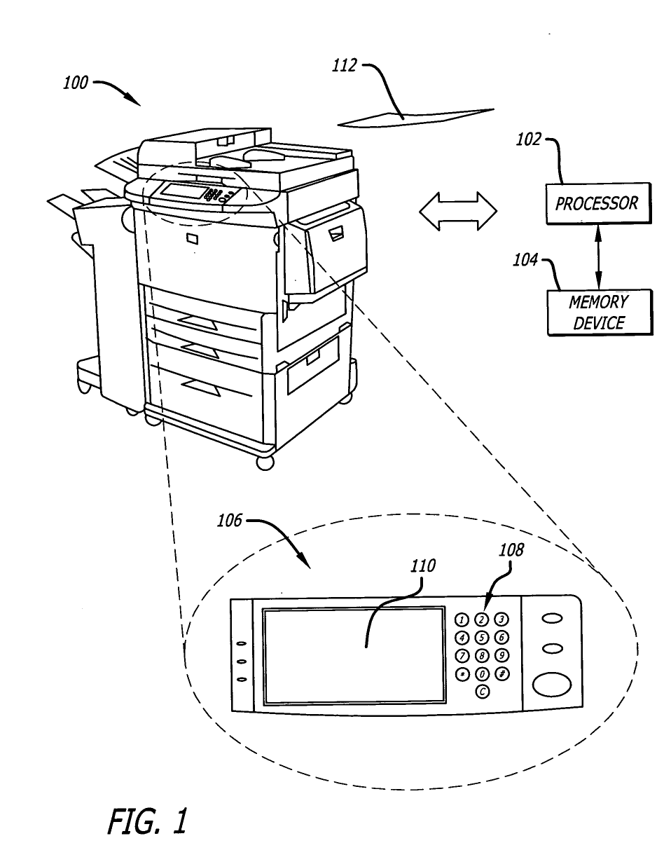

Referring to FIG. 1, an image producing device 100 (e.g., a HP LaserJet 9000MFP) is configured according to the present invention with a processor 102 and a memory device 104. The processor 102 and/or the memory device 104 can be part of the image producing device 100, or remotely located and operatively interfaced with the image producing device 100. In this example embodiment, the image producing device 100 has a control panel 106 with a plurality of user input and display mechanisms including a touch screen 110 and a numeric keypad 108. The image producing device 100 has the conventional capability of being able to scan an image (e.g., of a piece of media 112) into a memory device.

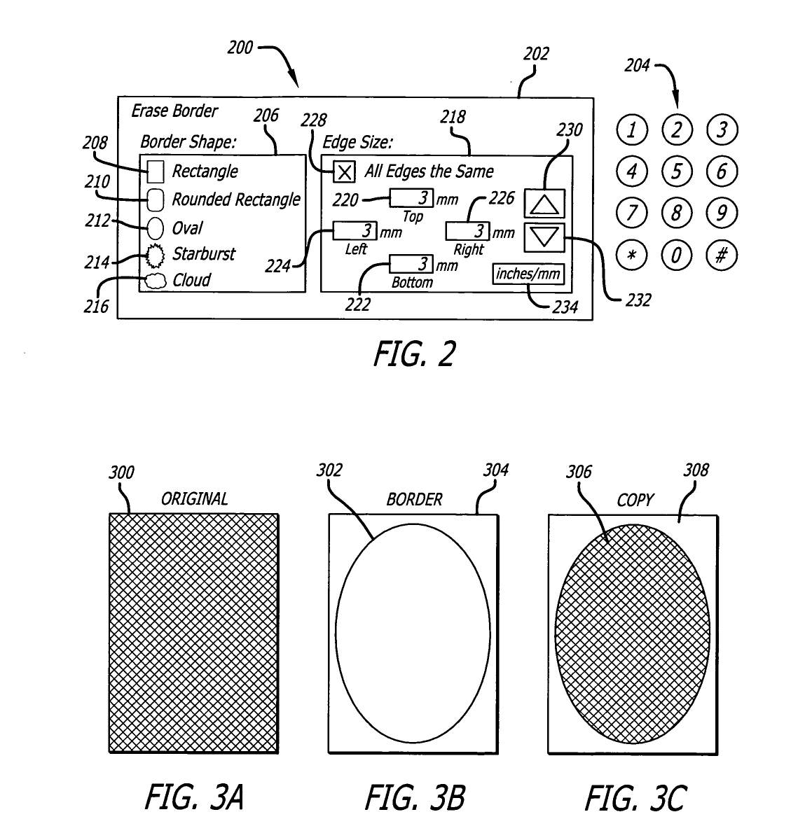

FIG. 2 illustrates an example embodiment of a user interface 200 for an image producing device configured according to the present invention. In this example, the user interface 200 includes a touch screen interface 202 and a numeric keypad 204. The user interface 202 provides a mechanism for selecting an image masking boundary with a non-rectangular shape from a plurality of differently shaped image masking boundaries and for modifying the image masking boundary. In this example, the touch screen interface 202 includes a menu 206 of image masking boundaries that are selectable by touching appropriate portions of the menu 206. In this example embodiment, the menu 206 is controlled to display image masking boundary icons 208, 210, 212, 214 and 216 as outlined in portions of the menu 206 shaped as a rectangle, a rounded rectangle, an oval, a starburst and a cloud, respectively. It should be understood, however, that the present invention is not limited to user interfaces with any particular selection or combination of image masking boundary shapes. Moreover, mechanisms for selecting an image masking boundary are not limited to touch screen interfaces.

In this example, the touch screen interface 202 also includes an image masking boundary modification interface 218 which includes input fields that are selectable by touching appropriate portions of the image masking boundary modification interface 218. In this example embodiment, the image masking boundary modification interface 218 is controlled to display edge distance input fields 220, 222, 224 and 226 which allow a user to enter top, bottom, left and right edge distances, respectively, and an “all edges the same” input field 228 which allows a user to designate that all edge distances are to be the same. In this example, the image masking boundary modification interface 218 is also controlled to display an increase edge distance input field 230, a decrease edge distance input field 232 and a select edge distance dimensions input field 234. In this example, the image masking boundary modification interface 218 is controlled to allow a user to input numeric values into the edge distance input fields 220, 222, 224 and 226 using the numeric keypad 204, the increase edge distance input field 230, the decrease edge distance input field 232, or any combination of these user input mechanisms. It should be understood, however, that mechanisms for modifying an image masking boundary are not limited to touch screen interfaces or keypads.

By way of example, and referring also to FIG. 1, a user places a piece of media 112 (such as a photograph) on the scanner glass or in the automatic document feeder of the image producing device 100. Next, the user selects an option, e.g., on a touch screen of the image producing device 100, to copy only a selected region of the original document. Referring to FIG. 2, the user selects an image masking boundary shape from the menu 206 by touching one of the icons 208, 210, 212, 214 and 216. In various embodiments, a selected image masking boundary defines a region with a center point that is either automatically positioned (e.g., centered and fit within the boundary of an image to be produced by the image producing device 100) or positioned in response to inputs (e.g., vertical and/or horizontal positional offsets) provided by the user. If desired, the user can modify the selected image masking boundary using the image masking boundary modification interface 218. For example, the user can set distances between the selected image masking boundary and the boundary of an image to be produced by the image producing device 100 by selecting one or more of the edge distance input fields 220, 222, 224 and 226 and inputting edge distance values using one or more of the numeric keypad 204, the increase edge distance input field 230 and the decrease edge distance input field 232. In this example, “3” was input as an edge distance, “mm” was selected as the edge distance dimension using the edge distance dimensions input field 234, and all of the edge distances were set equal by activating the “all edges the same” input field 228. If desired, the user can make additional copy settings before pressing the Start key (“not shown”) to begin copying. After the copy job is started, and referring to FIG. 3A, an example original image 300 is scanned to create image data. The processor 102 receives and processes inputs made at the user interface 200 to modify image masking boundary shape template data stored in the memory device 104. In the absence of user inputs to this end, in various embodiments, default settings stored in the memory device 104 (e.g., 3 mm edge distance for all four sides whenever the oval shaped image masking boundary is selected) are used by the processor to determine how an image masking boundary will be applied to the image data; for example, such defaults can change depending upon which image boundary masking shape is to be used, the sizes of the source and target pieces of media, and other considerations. In this example, and referring also to FIG. 3B, the user selected the oval shaped image masking boundary, resulting in an oval (or elliptical) shaped image masking boundary 302 positioned as shown within a boundary 304 of the image to be produced by the image producing device 100. Referring to FIG. 3C, in this example, the image masking boundary was used to define a portion 306 within which the image 300 is to be presented, and a portion 308 (outside of the applied image masking boundary) which is to be discarded, occluded or modified in some fashion. In this example, the portion 308 is filled with white pixels such that only portions of the image 300 inside the defined copy region are printed, thereby providing a “masked image”.

Thus, according to an example embodiment of the present invention, an apparatus for presenting an image includes a mechanism for selecting an image masking boundary with a non-rectangular shape from a plurality of differently shaped image masking boundaries and for modifying the image masking boundary, and an image producing device configured to apply the image masking boundary to an image to generate a masked image. By way of example, the mechanism for selecting can be provided through a user interface of the image producing device. Alternatively, the mechanism for selecting can be remotely located relative to the image producing device. The image producing device can be configured to generate the masked image by modifying a portion of the image that is outside the image masking boundary. For example, the portion of the image that is outside the image masking boundary can be occluded. Also by way of example, the portion of the image that is outside the image masking boundary can be generated to include pixels that are substantially uniform in color (e.g., white or black). The apparatus for presenting an image can also include a mechanism for scaling the image, a mechanism for scaling the image masking boundary, and/or a mechanism for repositioning the image masking boundary in relation to the image.

In another example embodiment, a method for presenting an image includes providing, to an image producing device, an image masking boundary that was selected by a user of the image producing device from a plurality of differently shaped image masking boundaries, and generating a masked image with the image producing device by applying the image masking boundary to an image and modifying a portion of the image that is outside the image masking boundary. The step of generating the masked image can include one or more of: fitting the image to the image masking boundary, scaling the image to fit within the image masking boundary, scaling the image to fill the image masking boundary, and scaling the image masking boundary. Fitting the image to the image masking boundary results in at least part of the image being bounded by the image masking boundary. Fitting the image to the image masking boundary can, but does not necessarily, result in the entire image being fitted within the image masking boundary. Scaling the image to fit within the image masking boundary results in an image that is sufficiently small in size to completely fit within the image masking boundary. Scaling the image to fill the image masking boundary results in an image that is sufficiently large in size to completely fill the image masking boundary. Scaling the image masking boundary means increasing or decreasing the size of the image masking boundary.

With respect to processing, in an example embodiment, the image producing device 100 determines or is provided with (e.g., from the user inputs or data stored in the memory device 104): size of source media, page width (X) and height (Y); image masking boundary shape and edge borders, Top (T), Bottom (B), Left (L), and Right (R); center point (C) and shape width (W) and height (H) (assuming origin (0, 0) at top left), wherein
W=X−L−R
H=Y−T−B
C=((L+(W/2)), (T+(H/2))).
Some aspects of shape generation for the image masking boundary can be provided by default parameters, by way of example, corner radius for rounded rectangles, number of points, depth, and angles for starbursts, number and radius of scallops for clouds, etc. In this example, the processor 102 is configured to compute the shape boundary using W, H, and default shape parameters, and a formula defined for each shape. The shape boundary is used to create a “mask” image in memory containing, for example, white or black pixels to define the part of the image to be erased. In this example, the image producing device 100 scans the original page and saves the image data to memory, the original image is combined with the mask image using Boolean logic (AND/OR) to create a copy image, with the proper border pixels erased (depending upon either default settings or using specified edge sizes), and the copy image is printed on the desired piece of media.

In various embodiments of the present invention, a selected image masking boundary can be modified in ways that are more complex than up-scaling (increasing in size), down-scaling (decreasing in size), or offsetting in position. For example, an image masking boundary can be rotated, anamorphically compressed or expanded, or scaled in a nonlinear fashion. Also by way of example, an image masking boundary can be scaled along one axis (e.g., along the scan direction), but not along the axis orthogonal thereto (e.g., along the feed direction), or vice versa.

Generally, boundary formulas are used to define the image masking boundaries and to determine whether pixels in an image area to which a particular image masking boundary is to be applied are inside or outside of the image masking boundary. For example, bitmap masks for each shape are pre-stored on a memory device accessible to the image producing device 100 and, more specifically, to the processor 102. The pre-stored bitmap masks for each shape can be for a particular size of target media (e.g., 4″×6″ page size), and then scaled as appropriate for other target media sizes. Bitmap masks (whether pre-stored or otherwise) provide a mechanism for applying the image masking boundary to an image to generate a masked image. Thus, according to an example embodiment of the present invention, an apparatus for presenting an image includes a user interface configured to allow a user of an image producing device to select an image masking boundary with a non-rectangular shape from a plurality of differently shaped image masking boundaries, and to modify the image masking boundary, and a mechanism for applying the image masking boundary to an image to generate a masked image. In an example embodiment of the present invention, the masking is performed on different portions of the image at different times (e.g., one line at a time), rather than on the entire image at once.

According to an example embodiment of the present invention, an apparatus for presenting an image includes an image producing device, a user interface, and a processor configured to control the user interface to allow a user of the image producing device to select an image masking boundary with a non-rectangular shape from a plurality of differently shaped image masking boundaries and to modify the image masking boundary, and determine data for a masked image to be generated by the image producing device by applying the image masking boundary to an image and modifying a portion of the image that is outside the image masking boundary.

According to another example embodiment of the present invention, a method for presenting an image includes providing, to an image producing device, an image masking boundary that is non-rectangular in shape, and generating a masked image with the image producing device by applying the image masking boundary to an image and modifying a portion of the image that is outside the image masking boundary.

According to an example embodiment of the present invention, a method for presenting an image includes selecting an image masking boundary with a non-rectangular shape from a plurality of differently shaped image masking boundaries, modifying the image masking boundary, and initiating an image processing operation to be performed by an image processing device using the image masking boundary as an input. The step of modifying the image masking boundary can include providing a boundary adjustment input at a user interface mechanism that is operatively connected to the image producing device. The image processing operation can include applying the image masking boundary to an image and modifying a portion of the image that is outside the image masking boundary to generate a masked image.

According to an example embodiment of the present invention, a method for presenting an image includes providing access to a machine-readable program that, when executed, enables a processor to control a user input mechanism to allow a user of an image producing device to select an image masking boundary with a non-rectangular shape from a plurality of differently shaped image masking boundaries and to modify the image masking boundary, and process an image using the image masking boundary to generate a masked image. For example, the machine-readable program enables the processor to control the user input mechanism to allow the user of the image producing device to scale the image, to scale the image masking boundary, and/or to reposition the image masking boundary in relation to the image. Also by way of example, the machine-readable program enables the processor to generate the masked image by applying the image masking boundary to the image and modifying a portion of the image that is outside the image masking boundary.

According to an example embodiment of the present invention, an apparatus for presenting an image includes a memory device upon which is stored a machine-readable program that, when executed, enables a processor to control a user input mechanism to allow a user of an image producing device to select an image masking boundary with a non-rectangular shape from a plurality of differently shaped image masking boundaries and to modify the image masking boundary, and process an image using the image masking boundary to generate a masked image. For example, the machine-readable program enables the processor to control the user input mechanism to allow the user of the image producing device to scale the image, to scale the image masking boundary, and/or to reposition the image masking boundary in relation to the image. Also by way of example, the machine-readable program enables the processor to generate the masked image by applying the image masking boundary to the image and modifying a portion of the image that is outside the image masking boundary.

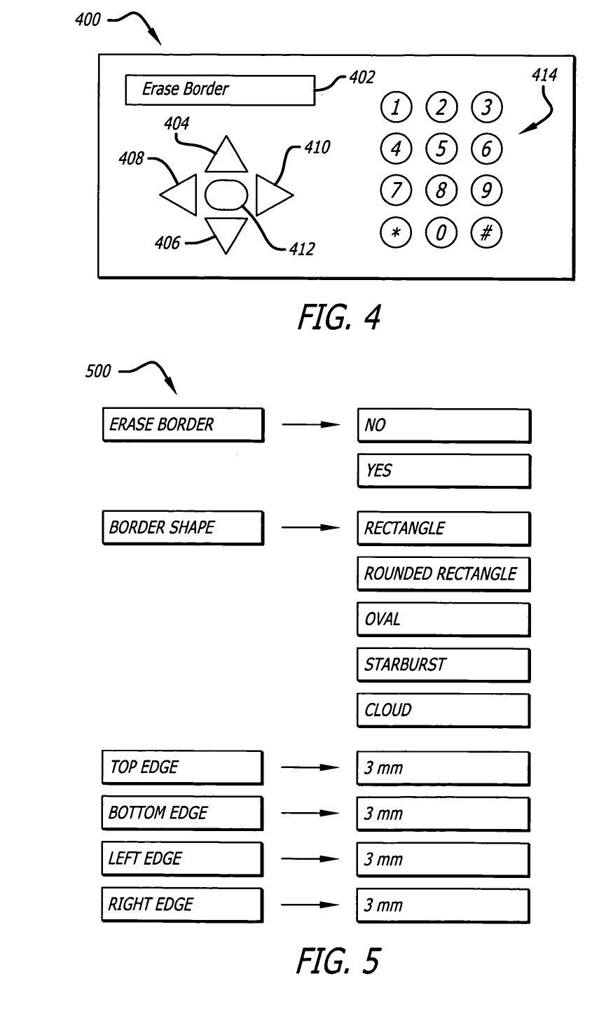

It should further be appreciated that the principles of the present invention are also suitable for implementation via a user interface that has fewer display lines that the user interface shown in FIG. 2. Referring to FIG. 4, an example embodiment of a user interface 400 includes a one-line display 402, input mechanisms 404, 406, 408, 410 and 412, and a numeric keypad 414 configured as shown. The input mechanisms 404, 406, 408, 410 and 412 allows a user to provide up, down, left, right and enter inputs for the purpose of navigating through a menu structure 500 (FIG. 5) providing user input options similar to those provided through the user interface 200 previously described. The simpler user interface 400 allows various embodiments of the present invention to be implemented on less expensive image producing devices that typically are not configured with large displays, smaller multifunction peripheral device, etc.

In an example embodiment illustrated in FIG. 7, a process 700 begins at step 702 where a user employs a touchscreen, single-line display, or other mechanism to enable Erase Border functionality. At step 704, the user selects Erase Border pertaining to border shape and position, including items such as edge positions, black or white border, etc. In this example, default values apply unless otherwise specified by the user. At step 706, the user selects other copy settings, such as image quality enhancements, scaling options, paper sizes, number of copies, etc. Input and output sizes are specified at this step if the device cannot automatically determine both sizes. At step 708, the user places one or more pages of the original document on the device, feeds the document, etc., according to device copy usage. At step 710, the user presses the Start button to initiate the copy process. At step 712, the device loads the pre-saved mask image from hard disk to memory. By way of example, the device contains pre-saved mask images for each supported shape, at one standard size (such as 8 inches by 10 inches, or 5 inches by 7 inches). Each mask image is defined by binary pixel data, where a value of 1 indicates the pixel is inside the border, and a value of 0 indicates the pixel is outside the border. Pixels inside the border represent the area of the original image to be printed, or presented. Pixels outside the border represent the area of the original image to be masked or occluded.

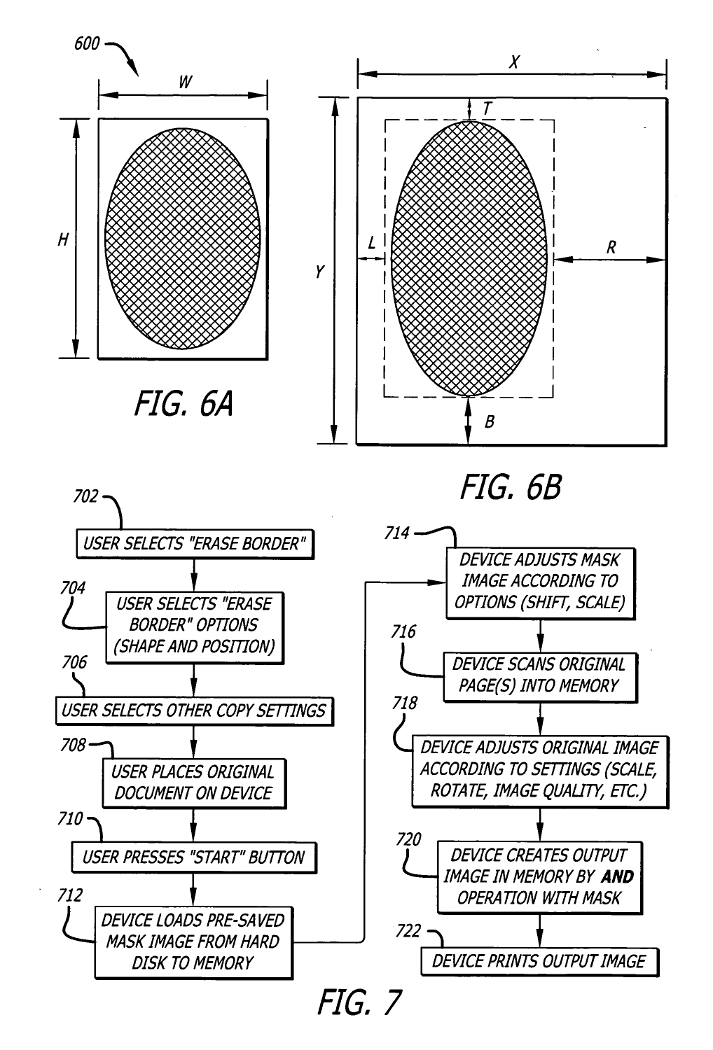

Referring to FIG. 6A, the pre-saved mask image 600 is of width W and height H, with black pixels being inside the border. Returning to FIG. 7, at step 714, the device adjusts the mask image according to the selected options (e.g., shift, scale). In this step, the device adjusts the mask image to fit the proper size and position according to the desired (selected) options and image sizes. The desired mask position and size are calculated using the output page size and the top, bottom, left, and right edge dimensions specified by the user. The mask image is shifted to the proper position and scaled to the proper width and height. The result of these operations is an image mask of the same dimensions as the output image, with all pixels set to a value of 0 unless they fall within the border of the adjusted mask.

Referring to FIG. 6A, the original mask image has width W and height H. Referring to FIG. 6B, the desired output page size has width X and height Y. The user-specified borders are top T, bottom B, left L, and right R. The original mask image data and these parameters are processed as discussed above to create the adjusted mask image. At step 716, the device scans the original page(s) into memory, according to normal copier usage. The result is a digital image representation of the original document. At step 718, the device adjusts the original image according to settings (scale, rotate, image quality, etc.) At this step, the device performs image manipulation functions on the original image, including scaling to fit the output image size, and any other specified settings. At step 720, the device creates an output image in memory by AND operation with the mask. The device now has both the original and the mask images in memory, adjusted accordingly to fit the output dimensions. In this example, binary “AND” logic is used for each pixel to determine whether it gets printed or masked. Pixels falling within the border are printed directly from the original image data. Pixels falling outside the border are occluded, or masked, and may be printed as completely black or white, depending on selected options. The effect is that a border is created around the original image according to the desired shape and dimensions. At step 722, once the determination is made as to how each pixel should be presented, the device prints the output image on the desired output paper or other article of media. Steps 720 and 722 can be performed one line at a time, rather than one page at a time. Rather than using pre-saved image mask templates, steps 712, 714 and 720 can be performed using a computational approach. This involves, by way of example, using pre-saved mathematical formulas to define the shape boundaries, formulas that are adjusted for scale and position. With respect to step 720, computational methods can be used to determine whether each pixel falls inside or outside the border.

Although the present invention has been described in terms of the example embodiments above, numerous modifications and/or additions to the above-described embodiments would be readily apparent to one skilled in the art. It is intended that the scope of the present invention extends to all such modifications and/or additions.

1. A method for presenting an image, comprising:
providing, to an image producing device, an image masking boundary that is non-rectangular in shape; and
generating a masked image with the image producing device by applying the image masking boundary to an image and modifying a portion of the image that is outside the image masking boundary.

2. The method for presenting an image of claim 1, wherein the image masking boundary includes one or more curved portions.

3. The method for presenting an image of claim 1, wherein the image masking boundary includes one or more rounded corner portions.

4. The method for presenting an image of claim 1, wherein the image masking boundary is elliptical in shape.

5. The method for presenting an image of claim 1, wherein the image masking boundary is polygonal in shape.

6. The method for presenting an image of claim 1, wherein the image masking boundary is starburst-shaped.

7. The method for presenting an image of claim 1, wherein the image masking boundary is cloud-shaped.

8. The method for presenting an image of claim 1, wherein the portion of the image that is outside the image masking boundary is occluded in the masked image.

9. The method for presenting an image of claim 1, wherein the portion of the image that is outside the image masking boundary is generated to include pixels that are substantially uniform in color in the masked image.

10. The method for presenting an image of claim 1, wherein generating the masked image includes fitting the image to the image masking boundary.

11. The method for presenting an image of claim 1, wherein generating the masked image includes scaling the image to fit within the image masking boundary.

12. The method for presenting an image of claim 1, wherein generating the masked image includes scaling the image to fill the image masking boundary.

13. The method for presenting an image of claim 1, wherein generating the masked image includes scaling the image masking boundary.

14. A method for presenting an image, comprising:
providing, to an image producing device, an image masking boundary that was selected by a user of the image producing device from a plurality of differently shaped image masking boundaries; and
generating a masked image with the image producing device by applying the image masking boundary to an image and modifying a portion of the image that is outside the image masking boundary.

15. The method for presenting an image of claim 14, wherein generating the masked image includes fitting the image to the image masking boundary.

16. The method for presenting an image of claim 14, wherein generating the masked image includes scaling the image to fit within the image masking boundary.

17. The method for presenting an image of claim 14, wherein generating the masked image includes scaling the image to fill the image masking boundary.

18. The method for presenting an image of claim 14, wherein generating the masked image includes scaling the image masking boundary.

19. A method for presenting an image, comprising:
selecting an image masking boundary with a non-rectangular shape from a plurality of differently shaped image masking boundaries;
modifying the image masking boundary; and
initiating an image processing operation to be performed by an image processing device using the image masking boundary as an input.

20. The method for presenting an image of claim 19, wherein the image masking boundary is elliptical in shape.

21. The method for presenting an image of claim 19, wherein modifying the image masking boundary includes providing a boundary adjustment input at a user interface mechanism that is operatively connected to the image producing device.

22. The method for presenting an image of claim 19, further including:
scaling the image masking boundary.

23. The method for presenting an image of claim 19, wherein the image processing operation includes applying the image masking boundary to an image and modifying a portion of the image that is outside the image masking boundary to generate a masked image.

24. The method for presenting an image of claim 23, further including:
fitting the image to the image masking boundary.

25. The method for presenting an image of claim 23, further including:
scaling the image to fit within the image masking boundary.

26. The method for presenting an image of claim 23, further including:
scaling the image to fill the image masking boundary.

27. A method for presenting an image, comprising:
providing access to a machine-readable program that, when executed, enables a processor to
control a user input mechanism to allow a user of an image producing device to select an image masking boundary with a non-rectangular shape from a plurality of differently shaped image masking boundaries and to modify the image masking boundary, and
process an image using the image masking boundary to generate a masked image.

28. The method for presenting an image of claim 27, wherein the machine-readable program enables the processor to control the user input mechanism to allow the user of the image producing device to scale the image.

29. The method for presenting an image of claim 27, wherein the machine-readable program enables the processor to control the user input mechanism to allow the user of the image producing device to scale the image masking boundary.

30. The method for presenting an image of claim 27, wherein the machine-readable program enables the processor to control the user input mechanism to allow the user of the image producing device to reposition the image masking boundary in relation to the image.

31. The method for presenting an image of claim 27, wherein the machine-readable program enables the processor to generate the masked image by applying the image masking boundary to the image and modifying a portion of the image that is outside the image masking boundary.

32. An apparatus for presenting an image, comprising:
a memory device upon which is stored a machine-readable program that, when executed, enables a processor to
control a user input mechanism to allow a user of an image producing device to select an image masking boundary with a non-rectangular shape from a plurality of differently shaped image masking boundaries and to modify the image masking boundary, and
process an image using the image masking boundary to generate a masked image.

33. The apparatus for presenting an image of claim 32, wherein the machine-readable program enables the processor to control the user input mechanism to allow the user of the image producing device to scale the image.

34. The apparatus for presenting an image of claim 32, wherein the machine-readable program enables the processor to control the user input mechanism to allow the user of the image producing device to scale the image masking boundary.

35. The apparatus for presenting an image of claim 32, wherein the machine-readable program enables the processor to control the user input mechanism to allow the user of the image producing device to reposition the image masking boundary in relation to the image.

36. The apparatus for presenting an image of claim 32, wherein the machine-readable program enables the processor to generate the masked image by applying the image masking boundary to the image and modifying a portion of the image that is outside the image masking boundary.

37. An apparatus for presenting an image, comprising:
a user interface configured to allow a user of an image producing device to select an image masking boundary with a non-rectangular shape from a plurality of differently shaped image masking boundaries, and to modify the image masking boundary; and
means for applying the image masking boundary to an image to generate a masked image.

38. The apparatus for presenting an image of claim 37, wherein the user interface is configured to allow the user to scale the image masking boundary.

39. The apparatus for presenting an image of claim 37, wherein the user interface is configured to allow the user to reposition the image masking boundary in relation to the image.

40. An apparatus for presenting an image, comprising:
means for selecting an image masking boundary with a non-rectangular shape from a plurality of differently shaped image masking boundaries and for modifying the image masking boundary; and
an image producing device configured to apply the image masking boundary to an image to generate a masked image.

41. The apparatus for presenting an image of claim 40, wherein the image producing device includes a user interface, and the means for selecting is provided through the user interface.

42. The apparatus for presenting an image of claim 40, wherein the image masking boundary includes one or more curved portions.

43. The apparatus for presenting an image of claim 40, wherein the image masking boundary includes one or more rounded corner portions.

44. The apparatus for presenting an image of claim 40, wherein the image masking boundary is elliptical in shape.

45. The apparatus for presenting an image of claim 40, wherein the image masking boundary is polygonal in shape.

46. The apparatus for presenting an image of claim 40, wherein the image masking boundary is starburst-shaped.

47. The apparatus for presenting an image of claim 40, wherein the image masking boundary is cloud-shaped.

48. The apparatus for presenting an image of claim 40, wherein the image producing device is configured to generate the masked image by modifying a portion of the image that is outside the image masking boundary.

49. The apparatus for presenting an image of claim 48, wherein the portion of the image that is outside the image masking boundary is occluded.

50. The apparatus for presenting an image of claim 48, wherein the portion of the image that is outside the image masking boundary is generated to include pixels that are substantially uniform in color.

51. The apparatus for presenting an image of claim 40, further including:
means for scaling the image.

52. The apparatus for presenting an image of claim 40, further including:
means for scaling the image masking boundary.

53. The apparatus for presenting an image of claim 40, further including:
means for repositioning the image masking boundary in relation to the image.

54. An apparatus for presenting an image, comprising:
an image producing device;
a user interface; and
a processor configured to
control the user interface to allow a user of the image producing device to select an image masking boundary with a non-rectangular shape from a plurality of differently shaped image masking boundaries and to modify the image masking boundary, and
determine data for a masked image to be generated by the image producing device by applying the image masking boundary to an image and modifying a portion of the image that is outside the image masking boundary.

55. The apparatus for presenting an image of claim 54, wherein the user interface is configured to allow the user to scale the image.

56. The apparatus for presenting an image of claim 54, wherein the user interface is configured to allow the user to scale the image masking boundary.

57. The apparatus for presenting an image of claim 54 wherein the user interface is configured to allow the user to reposition the image masking boundary in relation to the image.

58. The apparatus for presenting an image of claim 54, wherein the processor is configured to control the user interface to allow the user to scale the image.

59. The apparatus for presenting an image of claim 54, wherein the processor is configured to control the user interface to allow the user to scale the image masking boundary.

60. The apparatus for presenting an image of claim 54, wherein the processor is configured to control the user interface to allow the user to reposition the image masking boundary in relation to the image.
